(19) United States
(12) Patent Application Publication
(10) Pub. No.: US 2021/0173904 A1
(43) Pub. Date: Jun. 10, 2021

(54) System and method for verifying a media file

(71) Applicant: saad almohizea, RIYADH (SA)

(72) Inventor: saad almohizea, RIYADH (SA)

(21) Appl. No.: 16/833,558

(22) Filed: Mar. 28, 2020

Related U.S. Application Data
(60) Provisional application No. 62/945,203, filed on Dec. 8, 2019.

(51) Int. Cl. G06F 21/16; G06F 16/955; G06F 16/957; G06F 16/958

(52) U.S. Cl. CPC G06F 21/16; G06F 16/972; G06F 16/9574; G06F 16/9566

(57) ABSTRACT

A system and a method for verifying a media file by a verification system 100. The system 100 verifies a media file including a photo or a video for an online network. The user provides a url link of the online network wherein the media file is to be uploaded. The user is asked to capture the media file from an imaging unit 120 then, liveness test is done on the captured media file to verify originality of the captured media file. Thereafter, the verification system stores a copy of the verified media file. The system prompts the user to publish the media file on the link of the online network, which is thereafter validated by the system.

### BACKGROUND

The present disclosure relates to a system and a method for verifying a media file, and specifically relates to the system and the method for verifying the authenticity of a media file including photos, videos, over the online network.

A major problem observed in Online Social Networks (OSNs) is the difficulty to verify the authenticity of media, such as photos or videos that have been shared and posted publicly or privately. It is easy to copy a photo from a webpage and post into one's social account as being their own or share as if it was just taken by one's own camera. Ironically, the World Wide Web that brought users together has also made it easier to commit fraud. Impersonating others is not easily caught and relies heavily on human input whether from victims or those working at that particular social networking website. Identifying fraud by humans takes time and is only possible after fraud has been committed. In many cases, social networking websites don't even bother to verify the identity of their users or what they share, because the websites believe in generating a huge amount of data without considering the authenticity of the data. Only a few networks employ humans for reviewing new user profiles and verify uploaded photos. Some of the networks ask the users for official identification papers, such as their passports to give an official verified signature. This is a breach of privacy and a daunting task which cannot be extended to every user and every posted photo, or video.

US application 20140040152 attempts to identify fake accounts in a social networking system, by calculating a magnitude of a cluster of accounts. The social networking system determines whether the accounts are fake when the magnitude of the cluster is less than a threshold value. It depends on the user's cluster of friends and needs time to determine whether an account is fake. It would be desirable to verify the profile photos of social accounts and photos or videos in general, in an easy and automated way for any user who wishes to do so, and preferably preemptively, without the help of that particular social network to deter others from stealing photos and posting it into their fake accounts, or posting fake or old photos.

The present disclosure is directed to alleviate one or more limitations stated above or any other limitations associated with the conventional systems.

Some of the objects of the system and the method of the present disclosure are aimed to verify the authenticity of the image/photo or videos that are uploaded online.

Thus, it is one object of the present subject matter to provide a system and a method for uploading a verified photo or a video and encoded with user details.

It is also an object of the present subject matter to provide the system and the method that enables a verifier to verify the suspicious photo or video and confirm whether it is original or fake.

It is yet another object of the present subject matter to provide a system and the method to verify the details of the photo or video, such as date of creation, name of the author (user) and the website on which it was first uploaded, and further provide these details to the verifier and deter fakers from stealing photos or videos.

### SUMMARY

This summary is provided to introduce aspects related to a system and a method for verifying a media file and the aspects are further described below in the detailed description. This summary is not intended to identify essential features of the claimed subject matter nor is it intended for use in determining or limiting the scope of the claimed subject matter.

In one non-limiting embodiment of the present disclosure, a method for verifying a media file for an online network is disclosed. The method comprising the steps of fetching a link of the online network wherein the media file is to be uploaded and capturing the media file from an imaging unit. The method includes performing a liveness test on the captured media file to verify originality of the captured media file. The method further includes publishing the encoded media file on the link of the online network and validating the published media file on the online network.

In an embodiment of the disclosure, the method includes validating the uploaded media file which further includes comparing the published media file with the copy of the verified media file stored in the data base.

In an embodiment of the disclosure, the method includes validating the uploaded media file which further includes confirming validation when the published media file is similar to verified media file beyond a predefined threshold.

In an embodiment of the disclosure, the method includes encoding the media file to provide a unique digital code or signature on the media file and watermarking.

In an embodiment of the disclosure the unique digital code includes information of the media file including date of creation, name of user, link of the online network profile where the media file was originally uploaded.

In an embodiment of the disclosure, the method includes performing the liveness test which includes capturing one or more frames for the media file from a live video streaming through said imaging unit.

In one non-limiting embodiment of the present disclosure, a method for verifying a media file is disclosed. The method comprising the steps of uploading the media file to be verified. The method includes comparing the uploaded media file with the media files already stored in a data base and verifying when there is a match with the uploaded media file and the media files already stored in the data base.

In one non-limiting embodiment of the present disclosure, a verification system for a media file is disclosed. The system comprises a processing unit configured to receive a web link of an online network wherein the media file is to be uploaded. The processing unit performs a liveness test on the media file to verify the originality of the captured media file. The system also includes a processing unit configured to encode said verified media file.

In an embodiment of the disclosure, the processing unit validates said media file by comparing published media file with the copy of the verified media file saved in the data base.

In an embodiment of the disclosure, the processing unit performs the liveness test includes capturing one or more frames for the media file from a live video streaming through said imaging unit.

### BRIEF DESCRIPTION OF ACCOMPANYING DRAWINGS

FIG. 1 illustrates an example system including an example computing device that is representative of one or more systems and/or devices that may implement the various techniques described herein.

FIG. 2 illustrates a flow diagram depicting a method for a verification of an image file, in accordance with an embodiment of the present disclosure.

FIG. 3 illustrates a flow diagram depicting a method for a verification and validation of an image file, in accordance with an embodiment of the present disclosure.

FIG. 4 illustrates a flow diagram depicting a method for a verification of a Unified Resource Locator (URL) by the verifier, in accordance with an embodiment of the present disclosure.

FIG. 5 illustrates a flow diagram depicting a method for a verification of an image or a photo by the verifier, in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

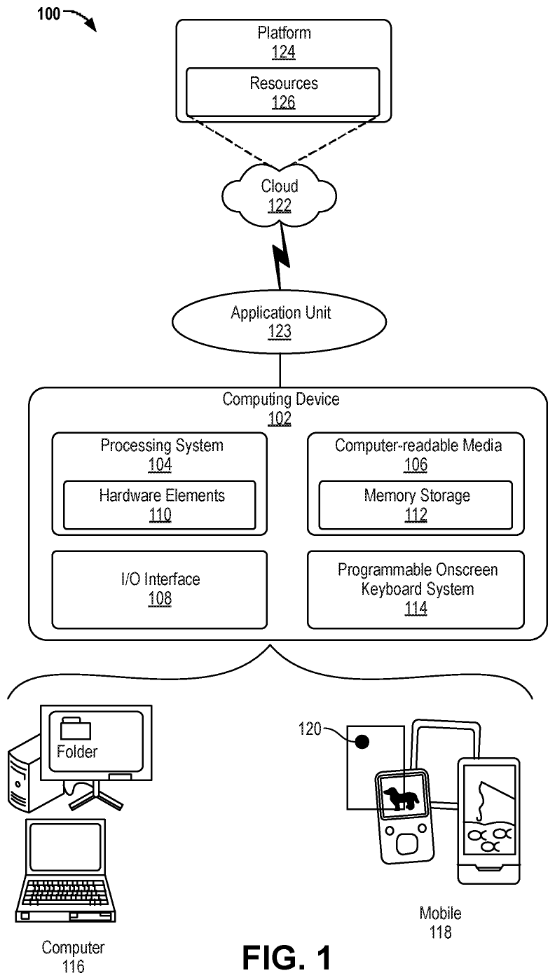

An embodiment of the present invention discloses a system and a method for the verification of a media file. The media file includes an image file or a video file. The system as disclosed herein and shown in FIG. 1, is a verification system 100 with a computing device 102. An example of the computing device 102 that is representative of one or more systems and/or devices that may implement the various techniques described herein. The computing device 102 may be, for example, a mobile device 118 and/or any other suitable computing device or computing system 116. The computing device 102 may includes instructions of a program that is in either in user's phones or mobile 118 as an application in a desktop computer 116. The program can also be available in the cloud 122 for the verification of the media file.

The computing device 102 as illustrated includes a processing system 104, one or more computer-readable media 106, and one or more I/O Interfaces 108 that are communicatively coupled, one to another. Although not shown, the computing device 102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system/unit 104 is representative of functionality to perform one or more operations using hardware. Accordingly, the processing system 104 is illustrated as including hardware elements 110 that may be configured as processors, functional blocks, and so forth. This may include implementation in hardware as an application specific integrated circuit or other logic device formed using one or more semiconductors. The hardware elements 110 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 106 is illustrated as including memory unit/storage 112. The memory unit/storage 112 represents memory/storage capacity associated with one or more computer-readable media. The memory/storage 112 may include volatile media (such as random access memory (RAM)) and/or nonvolatile media (such as read only memory (ROM), Resistive RAM (ReRAM), Flash memory, optical disks, magnetic disks, and so forth). The memory/storage 112 may include fixed media (e.g., RAM, RUM, a fixed hard drive, and so on) as well as removable media (e.g., Flash memory, a removable hard drive, an optical disc, and so forth).

The one or more input/output interface(s) 108 are representative of functionality to allow a user to enter commands and information to computing device 102, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera or imaging unit 120 (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 102 may be configured in a variety of ways as further described below to support user interaction.

The computing device 102 also includes a programmable on-screen keyboard system 114. The programmable on-screen keyboard system 114 provides various functionality for a programmable multi-touch on-screen keyboard as discussed above.

An implementation of the described modules and techniques may be stored on or transmitted across some form of computer-readable media 106. The computer-readable media 106 may include a variety of media that may be accessed by the computing device 102. By way of example, and not limitation, computer-readable media may include “computer-readable storage media” and “computer-readable signal media.”

“Computer-readable signal media” refers to a signal-bearing medium that is configured to transmit instructions to the hardware of the computing device 102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of it's characteristics set or changed in such a manner as to encode information in the signal. By way of example, and not limitation, communication media include wired media such as a wired network or direct-wired connection, and wireless media such as acoustic, RF, infrared, and other wireless media.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 110. The computing device 102 may be configured to implement particular instructions and/or functions corresponding to the software and/or hardware modules. Accordingly, implementation of modules as a module that is executable by the computing device 102 as software may be achieved at least partially in hardware, e.g., through use of computer-readable storage media and/or hardware elements 110 of the processing system. The instructions and/or functions may be executable/operable by one or more articles of manufacture (for example, one or more computing devices 102 and/or processing systems 104) to implement techniques, modules, and examples described herein. Hence aspects of the systems and methods provided herein encompass hardware like imaging unit 120 to capture video/photo and software for controlling the relevant functions. Software may take the form of code or executable instructions for causing a processor or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

In the example system 100, multiple devices are interconnected through a central computing device. The central computing device may be local to the multiple devices or may be located remotely from the multiple devices. In one or more embodiments, the central computing device may be a cloud 122 of one or more server computers that are connected to the multiple devices through a network, the Internet, or other data communication link.

The computing device 102 may also be implemented as the mobile 118 class of device that includes mobile devices, such as a mobile phone, a tablet computer, a multi-screen computer, and so on.

The techniques described herein may be supported by these various configurations of the computing device 102 and are not limited to the specific examples of the techniques described herein. This functionality may also be implemented all or in part through use of a distributed system, such as over a “cloud” 122 via a platform 124 as described below.

The cloud 122 includes and/or is representative of a platform 124 for resources 126. The platform 124 abstracts underlying functionality of hardware (e.g., servers) and software resources of the cloud 122. The resources 126 may include applications and/or data that can be utilized while computer processing is executed on servers that are remote from the computing device 102. Resources 126 can also include services provided over the Internet and/or through a subscriber network, such as a cellular or Wi-Fi network. Further, the communication functions can be facilitated through a network interface, such as one or more wireless communication subsystems, which can include radio frequency receivers and transmitters and/or optical (e.g., infrared) receivers and transmitters. the cloud includes a data base where verified and validated media files are stores along with the corresponding metadata such as the corresponding URL links, date of creation, user's name and and a log of past requests for verification, validation or confirmation as will be discussed later in detail.

The platform 124 may abstract resources and functions to connect the computing device 102 with other computing devices. The platform 124 may also serve to abstract scaling of resources to provide a corresponding level of scale to encountered demand for the resources 126 that are implemented via the platform 124. Accordingly, in an interconnected device embodiment, implementation of functionality described herein may be distributed throughout the system 100. For example, the functionality may be implemented in part on the computing device 102 as well as via the platform 124 that abstracts the functionality of the cloud 122.

The system also includes a processing unit to encode the media file with a watermark and or a unique digital code, which can be a QR code that contains information of the media file including date of creation, a name of author, a link of online network wherein the media file is originally uploaded. Likewise, the processing unit decodes the media file for extracting the relevant information including date of creation, a name of author (user), a link of online network wherein the media file is originally uploaded to verify the media file as and when desired by the verifier or user.

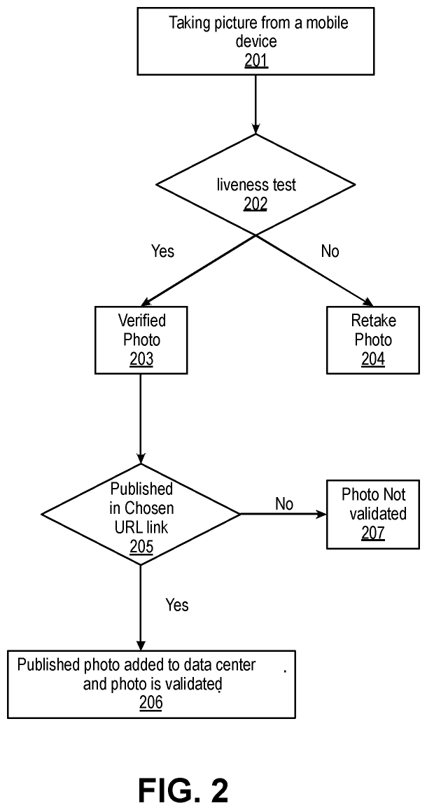

In an embodiment of the present invention, an overview of a method of verification of the media file is shown in FIG. 2, which depicts functionality of a system for a verification of an image or video file, in accordance with an embodiment of the present disclosure The method enables a user to verify the photo that he or she holds for being both original and linked to a particular web address. The method further tests for the originality or liveness to confirm whether the photos or videos are truly just created. Firstly, the user is asked to provide the Unified Resource Locators (URLs) link or web address of the destination for that photo or video in question. This could be the homepage of that social profile depending on what network is used in validation. This is where user's photo or video will appear and validated later by the verification system. Once the URL is provided to the verification system, the user is asked to take a photo or video 201, which is to be uploaded onto the URL. An imaging unit 120 is used to take a photo or video. The processing unit 104 receives the media file i.e. photo or video and stores it in the memory unit 112. Once the media file is received by the processing unit 104, it performs a liveness test or the originality test on the media file 202 to verify the originality of the captured media file. If the media file i.e. video or photo passes the liveness test or originality test, the media file is considered as a verified media file 203. Whereas if the media file fails the liveness test or originality test, the system 100 asks the user to take another one to verify 204. Once the media file is verified, the user is asked to publish the verified photo in the chosen URL link 205. If the media file is published onto the chosen URL link a copy of the published media is stored or saved in the database (data centre) as shown in step 206. If the media file is not published onto the URL link, the file is not validated as shown in step 207. it is understood that these instructions of the computing device, including the processing unit, computer readable media, memory unit and hardware elements can all be in the cloud whereas the imaging unit is always part of the device that the user has.

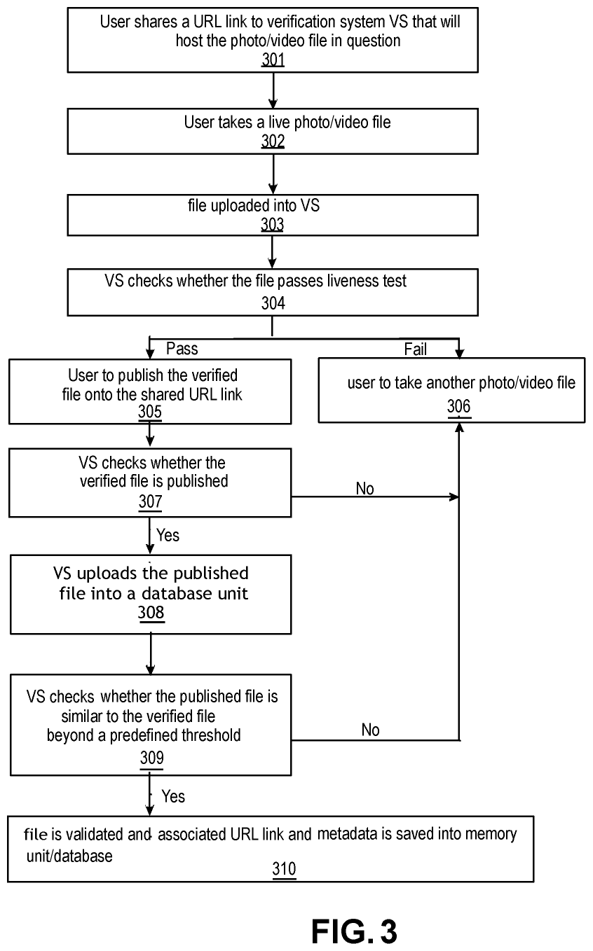

FIG. 3 shows in detail one embodiment of the present invention depicting a method for verification and validation of the media file. The user is asked to share a URL link to verification system 100 that will host the photo/video in question 301. Once the URL is shared with the system 100, the user takes a photo or video to be verified 302. The photo or video taken is uploaded onto the system 100. The photo or video can be either saved in the memory unit 112 or uploaded on the cloud 122 as per the case 303. The verification system 100 checks for the originality of the image or video by the liveness test 304. If the photo or video fails to clear the liveness test, the user is asked to take another photo or video 306. If the photo or video pass the liveness test, the user is asked to publish the verified photo onto the shared URL link 305. The system 100 thereafter checks whether the verified photo or video is published or not 307. Once the verified photo or video is published or uploaded, a copy of the published photo or video is saved 308 into the cloud 122 and optionally in the memory unit 112. The system thereafter checks whether the published photo or video is similar or identical to the originally verified photo or video beyond a predefined threshold 309. If the published photo or image is not identical or similar beyond a predefined threshold the user is asked to take another photo or video and proceed with the steps from 302-309. If identical or passes the threshold, then the photo or video is considered to be validated 310 and the validated photo or video is stored along with associated URL link and other metadata, such as date of creation and name of author (user). In a variation of the previous embodiment the metadata can be stored as unique digital signature or code which can be watermarked on the media file. The validated media file i.e. photo or video is always uploaded into the data base in the cloud to enable other verifiers to confirm if a media file is truly validated.

For the purpose of this disclosure, verifying a photo means that the photo has been found truly original and passed the liveness test. The validation which comes at the end can only be granted by the verification system 100 when the photo was verified and published or uploaded in the url link that was provided by the user. So every validated photo is also verified but not vice versa. Confirmation comes when verifiers would like the Verification System to check whether a photo is truly validated, and only when a photo is validated that a confirmation is sent back to the verifier.

In the preferred embodiment, an application unit 123 is an application which is preferably pre-installed in the smart phones or mobiles 118 and allows the verifiers to communicate with the verification system 100 and upload a Unified Resource Locators (URLs) and media files for the purpose of confirming a validation. The application also gives access to new authors (users) to verify suspicious media files, for the purpose of validation.

The Application unit 123 includes the application that preferably the verifier installs in his device. The application interacts with the data base available in the cloud. In a variation the application unit 123 can be available only in the cloud and the user communicate through a web browser. The application can also be available in both. The application unit decides whether the media file i.e. video or photo is live or not. Examples of the application include but are not limited to, an extension of a web browser, android application for smart phones or an application within a webpage.

In one embodiment, each newly validated photo is also encoded by a processing unit to watermark the photo or video with a unique digital code such as a QR code. The unique digital code includes information about the photo/video including metadata such as a URL of the web link where the verified image or video is published, a date of creation, name of author.

The liveness test or detection performed by the system 100 to verify originality of the image refers to checking whether a certain photo or video has been taken just now, and it proves that this file has not been copied from elsewhere from the web. Also, by proving the originality it is also proves that whoever submitted the file is most likely the author of that file and if a selfie is taken it almost always means that this is the real photo of the person intending to validate the photo. However, fakers can take a live photo from magazine covers. There are certain technologies which are known in the art to differentiate between a real face and a face on a paper or a screen and these technologies can be used. This relies mostly on physical attributes such as difference between 2d and 3d depth of perception or using infrared camera as the case with unlocking smart phones with face selfies. Other known methods include texture-based algorithms or even asking the person to perform certain gestures or move the head into certain directions. One method of liveness detection uses the camera's own functions to make changes in focus and zooming and expect temporal and equal changes in the recording. This is described by the inventor of this application in U.S. Pat. No. 10,499,119. In this case the changes are induced automatically by the verification system or manually by the user.

Preferably, for the purpose of verifying still photos, regardless of method of liveness test used, it is better to ask the user to send a live video stream or recording by an imaging unit 120, which is much harder to fake and easier to examine. Once the live video is taken by the user, then one photo corresponding to one of the frames of that video is chosen to be verified. If the whole video can be verified, then any frame taken from that video will be original and any photo taken from any frame from belonging to that video will be verified. proving originality in photos from just one shot, is harder than from photos belonging to a verified live stream. for example the verification system can control one of the many camera function responsible for taking a live stream, such as zooming, focusing or using the light flash. if the verification system 100 controls the imaging unit 120, so as to induce changes in live recording that are expected to be seen in the live recording in a temporal relation. such changes includes zooming in or out by a pre calculated amount of degrees. this proves originality of the recoding along with all of its frames as long as there is no interruption in the recording or discontinuation as described in detail by the inventor in U.S. Pat. No. 10,499,119. however, other techniques known in the art can also be used to verify liveness of media files.

If the photo doesn't pass the liveness test, then the user is asked to take another photo 306 as shown in FIG. 3. If the photo is verified after passing the liveness test then the user is asked to upload/publish the photo themselves to the online social profile or web link they provided in the beginning 305. The way social networks upload photos and index them into their system is variable from one another, and preferably a variation of the preferred embodiment is used for each one of them. The system is designed in such a way that it would work even if no application program interface (API) is granted to the system. This would provide a standard for photo verification and validation. It is understood that having such an API would facilitate integrating the VS system with the social network and reduces steps towards validation.

In a variation of the preferred embodiment, after the photo or video has passed the originality test 305, it is encoded i.e. a unique digital code or signature is created which includes information about the photo or video and the unique digital code or signature is encoded on the file is done for the file and sent back to the user for uploading it into the predefined URL provided earlier. the verification system can also operate without the process of encoding i.e. even if there is no watermark or the like digital code.

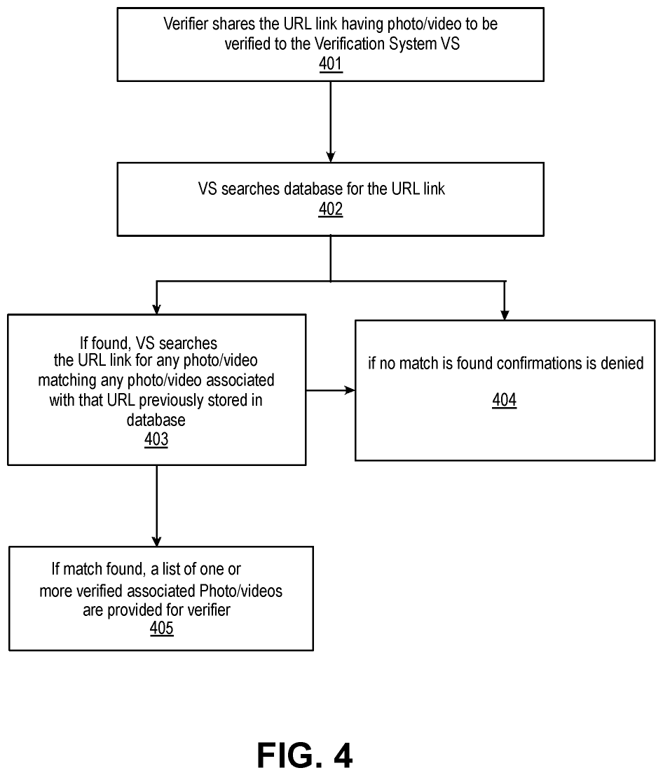

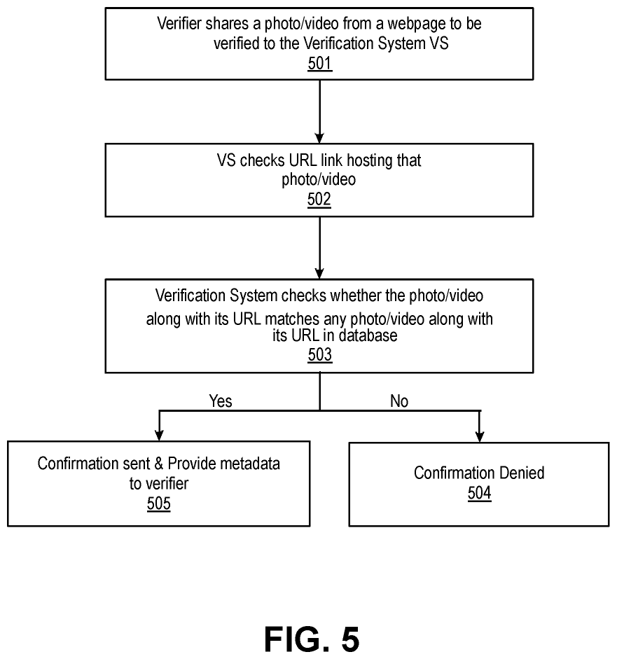

In a preferred embodiment, a method for verifying a media file is shown in FIG. 4 The verifiers in this embodiment are other people who would like to know if the photo in question is truly validated. If done, Watermarking will alert others that this photo can be checked by the system. If the verifier asks for a confirmation for what looks like a validated photo, and if the photo turns up in the data base and has a url link corresponding to what where the verifier found it, it gets a true confirmation verdict by the system. If someone else copies the photo (along with the watermark) and uses it somewhere else and claims to be the owner or creator of that photo, it can be easily debunked as shown in FIGS. 4 and 5. This is done easily by searching in the data base which didn't save that fake URL. Optionally, other metadata is provided to the user. If a faker uses the watermark logo on a photo, it will always be debunked because the photo watermark combination is not in the data base. If a faker tries to erase or smudge the watermark, it can be posted anywhere but it will lose it's value because there is no validation logo, And the photo would be just like any other photo in the web, which can be copied from anywhere. As an alternative of the preferred embodiment, the watermark can be a URL link for the web page where the photo was published and validated originally. in such case the verifier can tell instantly if the link in the watermark is the same as where the photo in question is hosted and the verification system can confirm that.

It is understood that even a validated watermarked photo or video can be shared and posted anywhere as long as there is no copyright issues or objection by the author. The system is especially useful when debunking when someone is claiming something that is false like impersonating a photo that they don't own. A watermarked verified and validated photo can be shared a thousand times with no issues but only the creator of the photo claims authorship. But even without a watermark, if a verifier has the verification application, they can always verify photos they come across. This can be done by known techniques like hashing the file. Hashing the photo and comparing the value to the photo that was stored in the data base earlier. Hashing is done with any method known in the art like the MD5 function. The validation process assures that even if the file gets shared many times and across platforms, as long as the verifiers have the means of confirmation (with a pre-installed application) they can always know who was the author (user) of that file, when was it created and bibliographic information such as contact information if provided by the user. any alteration even if subtle of the media file will preclude confirmation.

Referring to step 505 in FIG. 5, The verification system can send verdicts to verifiers in a different way based on the intension of the Author (user) whether he wishes to share the validated media file freely or not. In that case, the verification system gives corresponding metadata for the verifier, instead of sending just a confirmation for or against verification requests. And if the author doesn't wish to share his metadata, the system will just send a confirmation for or against the request without anymore details.

Some online social networks have different policies regarding how to deal with photos. For example, they may resize it or watermark it or change it for other reasons such as reframing it. Therefore, it is preferable that the verification system 100 keeps at least two copies of the photo in question, the originally verified photo during the liveness testing, and the published photo version (with or without the watermark). this is because it is possible that once published the social network it may not be exactly what the user has uploaded initially and was verified by VS. therefore VS can always compare verification requests with two files for each verifier request.

In an alternate embodiment, a similarity test is done between the published photo and the originally verified photo, if not found to be exact match. The similarity test is to make sure that photo is a true representation of the original photo and any deviation is only due to matters such as resizing and no major additions or deletions are attempted other than minimal changes such as for logo watermarking. Such techniques are known in the art and include technologies like scale-invariant feature transform (SIFT) feature detector or pixel-based approaches. Characteristically, a threshold is set beyond which the two photos are deemed not similar. In such case, the user is asked to take another live photo or video if the similarity test has failed.

FIGS. 4 and 5 describe how a verifier can make sure that a media file is truly validated. In one embodiment, a method for the verification of a photo in an online social profile or web link that looks suspicious is shown in FIG. 5. In this method the verifier is to share a photo or a video from a webpage, which looks suspicious and to be verified 501. sharing can be accomplished by communication with the system via the application 123. The system 100 checks for the URL which contains that photo or video 502. The system then searches the data base for any match 503. If a match is found, then the photo or video in question with it's URL link is compared to the one in records with it's corresponding URL, if it is a match then a true confirmation is given. The confirmation can also be given with the option of showing other metadata such as the date of creation and name of user 505. If the photo or video in question along with it's URL is not matched, then the verifier is notified that this photo can't be confirmed. if no match is found confirmation is denied 504. To have a confirmation the media file in question along with it's URL has to match both the media file and it's corresponding url in the data base.

In another embodiment, a method for the verification of a media file is shown in FIG. 4. In this method, a verifier can share the url link that hosts the photo in question through an application 401. The Application 123 is preferably pre-installed in the device. Here the verification system searches for a match of the URL link in the data base 402. If the match is found then the system scrapes the URL page provided by the verifier for any photos or videos, and searches for an exact match in the data base for that very same URL link 403. If one or more matches are found, then the verifier is notified the same way as in the previous method 405. In case no match is found, the verifier is notified that no photo or video is verified in that URL in question then the conformation is denied 404. To have a confirmation the media file in question along with it's URL has to match both the media file and it's corresponding url in the data base.

In a variation of the preferred embodiment the system 100 cancels the validation if the photo doesn't exist anymore at that specific saved URL. This is to ensure that once a photo has been validated, and associated with a specific URL, it must remain in that URL so as to keep the validation status as being active. The removal of a photo from the URL could be by mistake by the user or the website or even intended. In such cases, preferably the validation will either be deactivated or show that this was once validated and deactivated. Checking whether the validated photo is still public at the associated URL can be done periodically or every time a verifier requests a confirmation. preferably, In case the validation gets deactivated, a message is sent to the user.

It is understood that different websites have different policies regarding where and how a photo gets posted publicly. It might have it's own URL link with the only photo showing, or it could be within another link together with other photos, videos and text. Therefore, preferably, the system is better reconfigured for each website. Likewise, the way the photo might be cropped automatically or even resized or watermarked, this may change the hash value of that photo, in comparison to the originally verified photo. That's why the system saves a copy of the photo once it gets posted. In one variation, if the system can't save a specific URL of the photo because it keeps changing, then the validated photo can be associated with the homepage of that social profile which usually have the verified photo or within it's subdomains.

The system 100 can be used not only for main profile photos but also any photo or video in their social profile library, as long as the any photo or video is proven to be original and just created. This means that whoever holds the social account is most likely the one who took the photo or video.

It is advisable to provide the URL link before taking the photo because it limits what a hacker can do with the photo if he gets verified photo before it gets validated and associated with the social profile. However, as an alternative option, the link can also be provided after taking the photo. It is crucial to reduce the time from taking the photo for verification to the step of publishing the photo because that is a window for hackers to steal the photo and post as being their own. If a hacker attempts to steal the photo and post it somewhere after the photo Is validated, it will be easy to debunked if others ask for confirmation. preferably, the photo or video can only be validated for one social profile or URL link that is provided in the beginning. This means that the photo remains associated with the first or original URL even if the photo gets shared a thousand times, along with the date it got created.

In an alternate embodiment, the validation can be done on different fields other than online social networks such as with e-commerce, insurance fraud investigation, online dating sites, surveillance camera and journalism. If a verifier wants to check the authenticity of a photo for a listing of a merchandise or a room she is about to rent, she will not only wish to verify that this photo is not fake but also want the most recent unpolished unedited photo for that particular transaction. This can be assured if the photo is validated by the verification system with the date of creation made public. The system being a third party between customers and store provides unbiased assertion for credibility that enhances the completion of transactions.

In an alternate embodiment, a previously validated photo associated to a particular social profile can be challenged by the fact that the user may delete their account and their exact public URL link is given to someone else. Therefore, users are always reminded and asked to deactivate the validation if they delete or suspend that social account.

In an alternate embodiment, the verification system can provide the user with a record of attempts at confirmation for the photo from others, since the user has an access to his validated photo. the record may include the url link containing the photo in question provided by the verifiers. It can help the user stop any fake attempts by reporting it. This is crucial because a lot of networks are slow to react to fake photos and fake profiles and this allows the user who is the one at fault to take actions early and swiftly. This record can also be used by users to count how popular a file is across platforms because sharing or liking is a function specific to each and every social network but verification requests is gathered from all. Finally, the record can be used for actions against copyright infringements if the user wants to.

To further understand one of the advantages of the system a scenario is presented. If a photo is to be verified after passing liveness test and declared original, but photo is not linked to the specific url or social profile, it would have some shortcomings. The metadata in such scenario will give the day of creation (date stamp) and perhaps the name of the author (user). Now, if the verified photo is watermarked as being authentic with a link for anyone to check for originality, it will be easily copied by a faker and posted as being for him. The faker being able to get the metadata for this photo like anyone else and can create a social profile mirroring the name of the true author (user) having his original photo. This can be done by the faker in all social networks and by other fakers too. On the other hand, in our preferred embodiment since the photo can only be validated after being linked to a specific URL link for one social profile, any copy of that photo in any other social profile in that network or any other network will be debunked by the verification system. This will thwart fakers from using any validated photo. If the faker shares that image in a private message, and if the verifier at the other end checks the verification system, the system will direct the verifier to the social profile of the true author (user) of that photo. This paradigm will abort any faking attempts early on and fakers will look for other photos that hasn't been validated by the verification system. In short once a photo is validated and associated with one designated URL link, it is exceedingly hard to steal that photo and post publicly anywhere in the web and impersonate that person without getting caught.

It should be noted that various changes and modifications to the presently preferred embodiments described herein will be apparent to those skilled in the art. Such changes and modifications may be made without departing from the spirit and scope of the present invention and without diminishing it's attendant advantages.

Some embodiments of this disclosure, illustrating all it's features, will now be discussed in detail. The words “comprising”, “having”, and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any devices and methods similar or equivalent to those described herein can be used in the practice or testing of embodiments of the present disclosure, the exemplary devices and methods are now described. The disclosed embodiments are merely exemplary of the disclosure, which may be embodied in various forms.

1. A method for verifying a media file for an online network by a verification system having a data base, the method comprising the steps of:
providing a Unified Resource Locator wherein the media file is to be uploaded by a user to the verification system;
capturing the media file from an imaging unit by the user;
verifying originality on the captured media file by the verification system;
storing a copy of the verified media file in the data base;
publishing the verified media file on said Unified Resource Locator;
checking whether the verified media file has been published; and
validating the published media file.

2. The method of claim 1, wherein the validated media file is digitally encoded with a unique digital code.

3. The method of claim 1, wherein validating the media file further includes comparing the published media file with the copy of the verified media file.

4. The method of claim 3, wherein the media file is validated only when the published media file is similar to the copy of the verified media file beyond a predefined threshold.

5. The method of claim 1, wherein the validated media file is stored in the data base.

6. The method of claim 2, wherein the unique digital code includes metadata about a date of creation, a name of the user, and the Unified Resource Locator where the published media file was uploaded.

7. The method of claim 1, wherein the media file is watermarked by the verification system.

8. A method for confirming validation of a media file, by a verification system having a data base the method comprising the steps of:
uploading the media file to be verified along with a web address by a verifier to the verification system;
comparing the uploaded media file along with the web address with a plurality of media files along with a plurality of web addresses already stored in the data base; and
Confirming validation for the verifier when there is a match between the uploaded media file along with the web address with the plurality of media files along with the plurality of web addresses already stored in the data base.

9. The method of claim 8, further comprising the step of sending one or more metadata about the validated media file to the verifier after confirmation.

10. A method for confirming validation of a media file on an online network by a verification system having a plurality of saved media files with a plurality of corresponding web addresses on a data base, the method comprising the steps of:
fetching a web address by a verifier to the verification system;
scraping the web address for one or more media files;
comparing the scraped media files with the saved media files; and
Confirming validation to the verifier when there is a match between the scraped media files and the saved media files along with the corresponding web addresses.

11. The method of claim 10, further comprising the step of sending one or more metadata about the validated media file to the verifier after confirmation.

12. A verification system for a plurality of media files, the system comprises:
a data base configured to store the media files, and a plurality
of corresponding web addresses
a processing unit configured to:
receive the web address by a user where the media file is to be uploaded;
receive the media file captured by an imaging unit and store the media file in the data base;
perform a liveness test on the media file to verify the originality of the captured media file; and
Validate the media file after it gets published on the web address.

13. The system as claimed in claim 12, wherein the processing unit compares the stored media file with the published media file.

14. The system as claimed in claim 13, wherein the processing unit confirms validation only when the stored media is similar to the published media file beyond a predefined threshold.

15. The system as claimed in claim 12, wherein the processing unit encodes the media file with a unique digital signature

16. The system as claimed in claim 15, wherein the unique digital code includes information about the media file including a date of creation, a name of the user, and the web address where the media file was uploaded.

17. The system as claimed in claim 12, wherein the liveness test is performed in either a cloud or in a mobile device.

18. The system as claimed in claim 12, wherein the media file is watermarked by the processing unit.

19. The method of claim 12, wherein the validated media file is stored in the data base.
